(19) United States
(12) Patent Application Publication
(10) Pub. No.: US 2019/0109516 A1
(43) Pub. Date: Apr. 11, 2019

(54) FLUID PUMP WITH HEAT DISSIPATION

(71) Applicant: Bühler Motor GmbH, Nürnberg (DE)

(72) Inventor: Georg Bernreuther, Nürnberg (DE)

(73) Assignee: Bühler Motor GmbH, Nürnberg (DE)

(21) Appl. No.: 16/151,539

(22) Filed: Oct. 4, 2018

(30) Foreign Application Priority Data
Oct. 6, 2017 (DE) 10 2017 217 788.8

(51) Int. Cl. H02K 9/22; F04B 53/08; H02K 5/18

(52) U.S. Cl. CPC H02K 9/22; F04B 53/08; H02K 2209/00; F04B 2203/0205; H02K 5/18

(57) ABSTRACT

A fluid pump, having a pump impeller, mounted so as to rotate around an axle, in a conveyed medium in a wet area and a conductor plate, which is arranged in a dry area sealed off from the conveyed medium, wherein radial forces of the axle are accommodated, on one side, by a separating wall between the dry area and the wet area and by a pump head on the other side. The object of the invention is to provide structural features to ensure an optimum dissipation of heat from a conductor plate and its power components to the conveyed medium without negatively impacting the hydraulic efficiency of the pump.

### CROSS-REFERENCE TO RELATED APPLICATIONS

The present patent application is based on, and claims priority from, German Application No. DE 10 2017 217 788.8, filed Oct. 6, 2017, which is incorporated herein by reference in its entirety.

### BACKGROUND OF THE INVENTION

### (1) Field of the Invention

The invention relates to a fluid pump, having a pump impeller, mounted so as to rotate around an axle, in a conveyed medium and a conductor plate, which is arranged in a dry area sealed off from the conveyed medium, wherein radial forces of the axle are accommodated, on one side, by a separating wall between the dry area and the conveyed medium and by a pump head on the other side.

### (2) Description of the Related Art Including Information Disclosed Under 37 CFR 1.97 and 1.98

In what follows, fluid pumps having three-phase motors in a power range of about 30 W to 200 W electric power are considered in particular, without being limited to these.

Fluid pumps of the generic type, particularly motor vehicle water pumps, are often driven by an electronically commutated direct-current motor, which comprises multiple heat-generating components, which primarily include a wound stator and a conductor plate populated with power components. The stator and also the conductor plate are normally arranged directly at a separating wall, which seals off a dry area, in which the heat-generating components are arranged, from a wet area, through which conveyed medium flows. The stator is usually arranged radially with respect to the rotational axis of a pump impeller and the conductor plate is arranged at a right angle to its rotational axis. The pump impeller has, axially offset with respect to a hydraulic part, a magnetic part, which is arranged radially opposite the wound stator. Because the requirements for the power density increase with each product generation, it is necessary to dissipate the heat of the power components as well as possible to the surrounding components or preferably to the conveyed medium. The latter is particularly suited for continuous dissipation of the generated heat on account of the forced flow. In the cooling circuit of a combustion engine, this heat is then emitted, along with the exhaust heat from the combustion engine, to a water-air heat exchanger, which continuously dissipates heat to the environment by means of the headwind.

The transfer of heat from one component to another or to a medium is more successful the larger the surface areas, particularly the contact surfaces, between the areas involved and the better the thermal conductivity value of the materials used. However, dissipating the heat generated to a sufficient degree is frequently unsuccessful. This is because only a small flow of fluid is possible in the magnetically effective area of the wet space due to the narrow flow paths. On the other hand, there is a high volumetric flow, for example, in the intake area. Fluid pumps are also known in which a complex secondary circuit is set up, which diverts a part of the conveyed medium and passes by the heat generators in the electronic system and/or in the stator. However, the hydraulic efficiency is also negatively affected by this. A further disadvantage of a secondary circuit is caused by particles and suspended solids entrained in the conveyed medium. They can clog the secondary circuit and thus stop it up.

The use of high-quality components or the installation of multiple components connected in parallel can reduce the power loss and thus the heat development. Another way would be the use of more temperature-resistant conductor plate materials, e.g. ceramic conductor plates based on Al₂O₃. These measures, however, are subject to physical and above all cost-related limits.

### BRIEF SUMMARY OF THE INVENTION

The object of the invention is thus to provide structural measures to ensure an optimum dissipation of heat from a conductor plate and the power components mounted thereon to the conveyed medium without negatively impacting the hydraulic efficiency of the pump.

Because an essential part of the heat generated by electronic components on the conductor plate is discharged to the cooling medium by means of the heat-conducting path, which has the axle and an axle retainer as components, which transfers the radial forces of the axle from it to the separating wall or the pump head, there is an especially large usable surface area by means of which the heat can be discharged to the conveyed medium.

In a development of the concept of the invention, a provision is that a first axle retainer is fitted against a base of the separating wall, said base being arranged axially to an axis of rotation of the pump impeller. A further provision is that a second axle retainer is arranged in an intake duct of the pump head, and the conveyed medium at least partially flows around it during operation.

In what follows, several options are listed as to how the heat can be efficiently transferred from the power components to the heat-conducting plate. These options can in each case be used singly or in combination with one or more of the other options. First, it is proposed that the conductor plate have a plurality of vias forming a heat-conducting connection of power components through the conductor plate to their opposite side and is in heat-conducting contact with the heat-conducting plate directly there or via a heat-conducting medium.

A further option is that the conductor plate have at least one recess through which a power component extends and is directly in heat-conducting contact with the heat-conducting plate or via a heat-conducting medium.

It is also conceivable that at least one conductor of the conductor plate be directly in heat-conducting contact with the heat-conducting plate or via a heat-conducting medium. The heat-conducting plate preferably consists of aluminum or a material with comparable properties.

Finally, it is also possible for the heat-conducting plate to form at least one electric conductor or a conductor area of the conductor plate.

In principle, all shapes enlarging the surface area are suitable that enable demolding from an injection mold and fulfill the design rules for such shapes. The same applies to manufacture of the heat-conducting plate.

In order to transport as much heat as possible and in order to obtain the largest possible surface area in order to improve the transfer of heat, a provision is that the diameter of the axle be at least 20% of the diameter of the first axle retainer in the area of the contact disk. The axle discharges heat to its environment over its entire length in the conveyed medium; this can be optimized by the pump impeller being mounted on the axle by means of sleeve-like slide bearings, which divert a part of the heat absorbed by the axle to the pump impeller. To ensure this heat diversion is as great as possible, it is proposed that the length of a slide bearing correspond to at least 10% of the length of the axle.

For reasons related to production and cost, the pump head is preferably produced from a plastic material, which can be processed through injection molding. In order to secure the aforementioned advantages, a provision is that the second axle retainer be joined by molding to the pump head, particularly to an intake duct of the pump head. To this end, the thermal expansion coefficients should be as close to one another as possible. This is the case when pairing PPS and aluminum.

As an alternative, the second axle retainer is joined to the pump head, particularly to an intake duct of the pump head, through pressing with force locking and/or positive locking. Preferably, a cone is provided here between the pump head and the component consisting of the intake duct and second axle retainer. In addition, the connection can be secured through bonding, welding, or bolting. If the sealing requirements demand it, an O-ring seal can also be placed between the parts to be joined. Alternatively, a liquid sealant can also be used.

In the optimum case, the intake duct is a single-piece component of the second axle retainer. This enlarges the surface area of the heat-conducting parts again significantly. The intake duct in this case is preferably joined by molding to the pump head, wherein the pump head consists of a plastic material that can be processed using injection molding.

Ideally, at least one or preferably both axle retainers consists of an aluminum material. Essentially, it is important that the ratio between the diameter and length of the axle be greater than 0.1, particularly greater than 0.15, and preferably greater than 0.2. The larger this ratio, the greater the thermal flow and thus the cooling effect which can be achieved.

### BRIEF DESCRIPTION OF THE SEVERAL VIEWS OF THE DRAWINGS

The exemplary embodiments of the invention are subsequently further explained, based on the drawings. The following is shown:

FIG. 1 shows a sectional view through a fluid pump according to the invention,

FIG. 2a shows an axle with coatings,

FIG. 2b shows an axle with slide bearings,

FIG. 3 shows a first embodiment of an axle retainer in a pump head,

FIG. 4 shows a second embodiment of an axle retainer in a pump head,

FIG. 5 shows a third embodiment of an axle retainer in a pump head,

FIG. 6 shows a pump head with an intake duct,

FIG. 7 shows a conductor plate with a first embodiment of a heat-conducting plate,

FIG. 8 shows a conductor plate with a second embodiment of a heat-conducting plate,

FIG. 9 shows a conductor plate with a third embodiment of a heat-conducting plate; and

FIG. 10 shows a conductor plate with a fourth embodiment of a heat-conducting plate.

Note: The reference numbers with subscript and the corresponding reference numbers without subscript refer to details with the same name in the drawings and the drawing description. This reflects use in another embodiment and/or where the detail is a variant.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

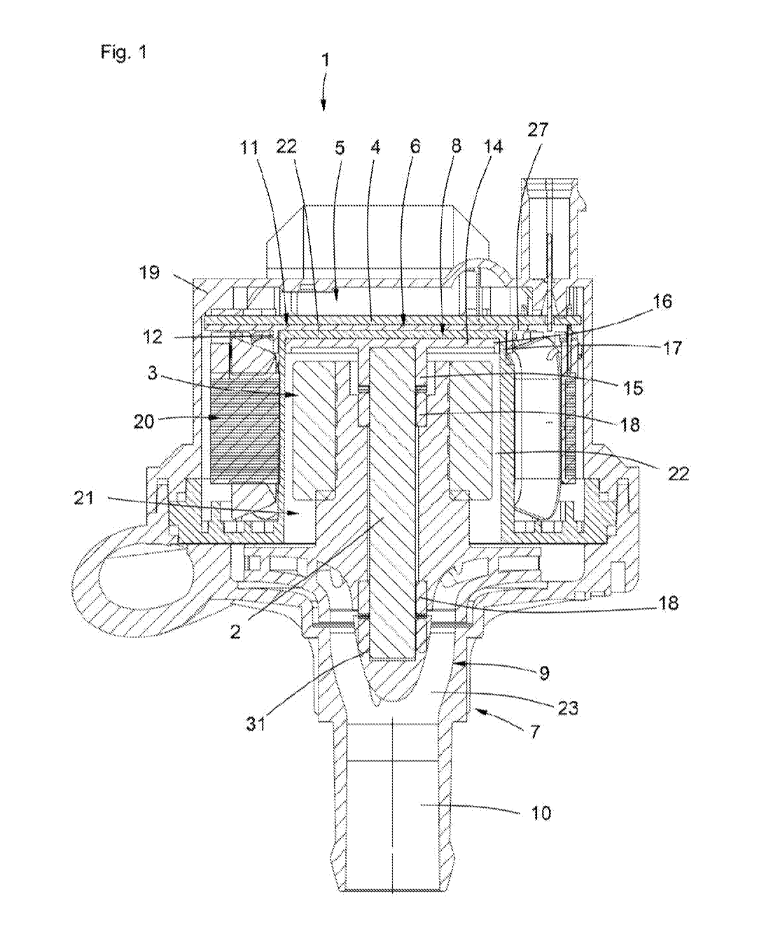

FIG. 1 shows a sectional view through a fluid pump 1 according to the invention, having a motor housing 19, a pump head 7, a separating wall 6, and a pump impeller 3. The motor housing 19 and the separating wall 6 form a dry area 5, in which a conductor plate 4, a wound stator 20, and a heat-conducting plate 11 are arranged. The separating wall 6 and the pump head 7 delimit a wet area 21, in which the pump impeller 3, a first axle retainer 8, a second axle retainer 9, and an axle 2 are arranged. The pump impeller 3 is rotatably mounted on the axle 2 via the slide bearing 18. The separating wall 6 consists of a tube-shaped area 17 and a disk-shaped area 22. The first axle retainer 8 has a contact disk 14, which from a retainer sleeve 15 to retain the axle 2 extends radially up to the tube-shaped area 17 of the separating wall 6. A support collar 16 connects to the contact disk 14, with the support collar abutting closely onto the tube-shaped area 17 of the separating wall 6 and, in this manner, enlarges the contact surface between the first axle retainer 8 and the separating wall 6. The separating wall 6 in this case is produced from a plastic material by means of an injection-molding process. The disk-shaped area 22 of the separating wall 6 is designed with very thin walls (e.g. 1 mm) to reduce the thermal resistance and obtains its stability by means of a sandwich layer between the heat-conducting plate 11 and the first axle retainer 8. Such a sandwich layer is partly present as well in the radial direction between the support collar 16 and a projecting wall 12 of the heat-conducting plate 11. The second axle retainer 9 consists of a metal material with good heat-conducting properties, while the pump head 7 with the intake duct 10 consists of a plastic material, which can be processed by injection molding. The second axle retainer 9 is connected to the intake duct 10 and thus to the pump head 7 by means of spokes 23. Since the conveyed medium flows through the intake duct 10 during operation, the heat, which is transferred to the second axle retainer 9 and the spokes 23 via the axle 2, is extensively discharged to the conveyed medium. In the example shown, three spokes 23 are provided (two being visible).

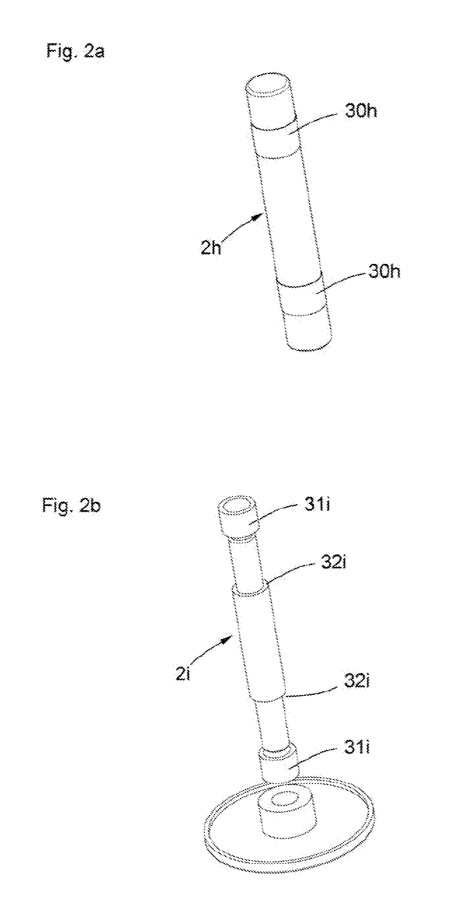

FIG. 2a shows an axle 2h, consisting of an aluminum material. To improve the wear properties, the axle 2 is provided with a beryllium layer 30h.

FIG. 2b shows an axle 2i, consisting of an aluminum material. To improve the wear properties, the axle 2i is provided with auxiliary slide bearings 31i at each end and are pressed into recesses 32i.

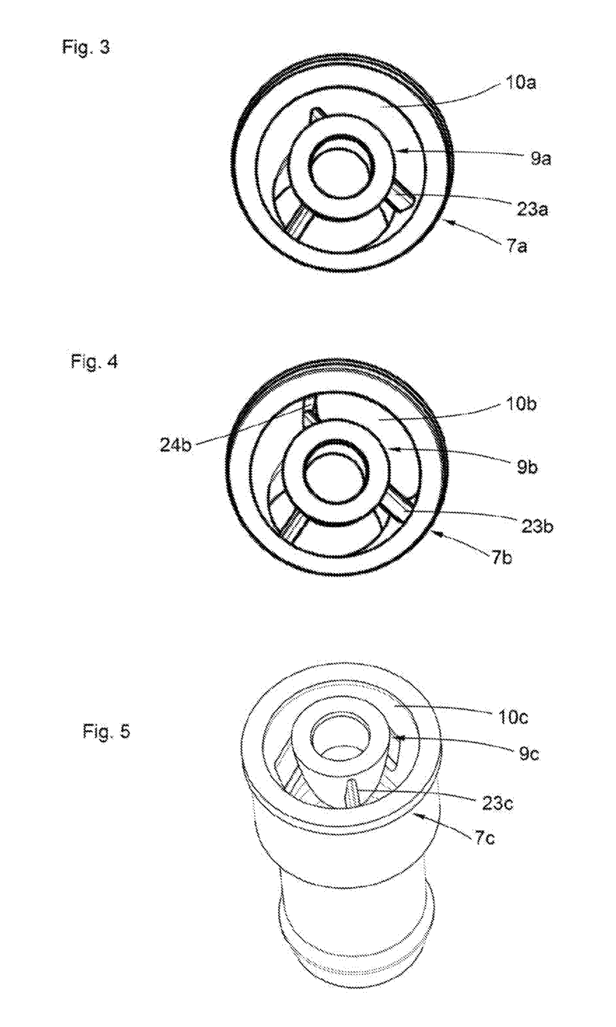

FIG. 3 shows a first embodiment of a second axle retainer 9a in a pump head 7a. The axle retainer 9a here is joined by molding to an intake duct 10a and thus to the pump head 7a (injection-molded).

FIG. 4 shows a second embodiment of a second axle retainer 9b in a pump head 7b. In this case, the axle retainer 9b is joined by pressing, wherein spokes 23b engage with grooves 24b provided for this of an intake duct 10b. Since the second axle retainer 9c is constantly impacted by the pump impeller 3 during operation, it is secured against unintentional removal.

FIG. 5 shows a third embodiment of a second axle retainer 9c in a pump head 7c. The second axle retainer 9c here is designed as a single piece with an intake duct 10c. The component consisting of the intake duct 10c and the axle retainer 9c is joined to a pump head 7c by a press fit. Since here too the second axle retainer 9c is constantly impacted by the pump impeller 3 during operation, it is secured against unintentional removal. A cone between the pump head and the second axle retainer 9c, whereby the retaining force is significantly increased, is not discernible.

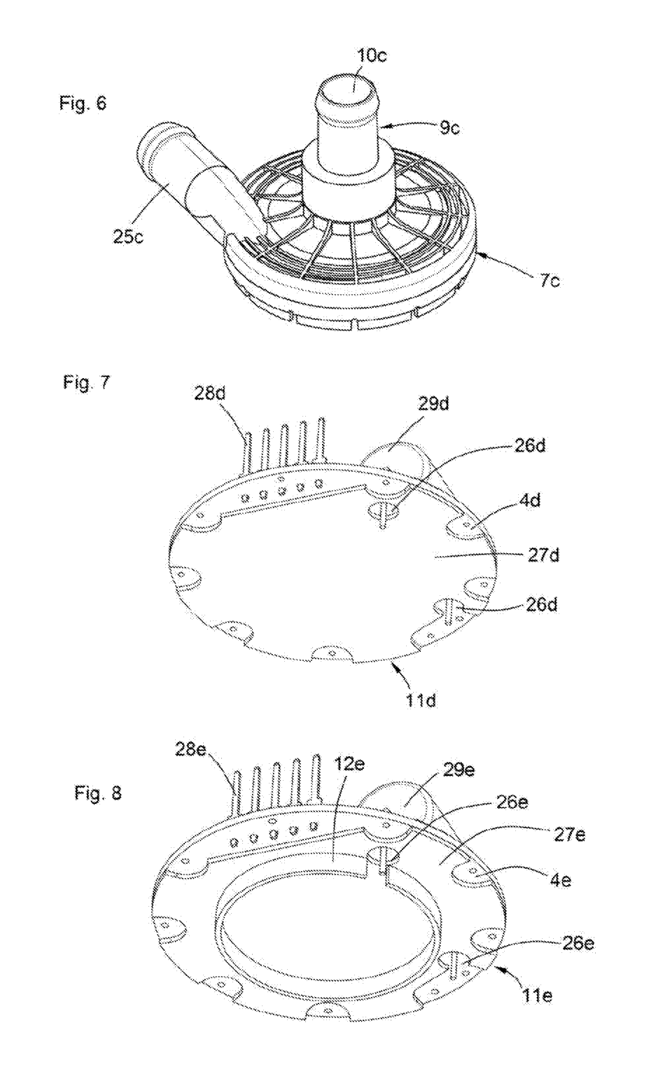

FIG. 6 shows the pump head 7c with the intake duct 10c and the second axle retainer 9c. The pump head 7c further has an output duct 25c.

FIG. 7 shows a conductor plate 4d with a first embodiment of a heat-conducting plate 11d. It takes the form of a flat plate 27d and has recesses, which are used as conductor feed-throughs 26d. Connection pins 28d and a capacitor 29d are also shown mounted on conductor plate 4d.

FIG. 8 shows a conductor plate 4e with a second embodiment of a heat-conducting plate 11e, which has a projecting wall 12e, which connects to a flat plate 27e.

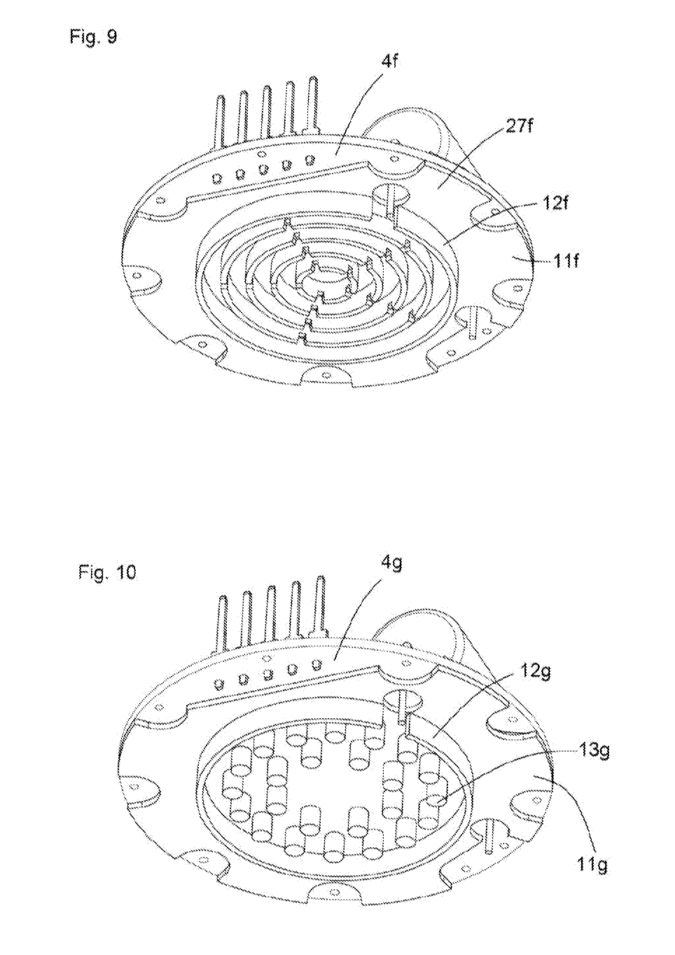

FIG. 9 shows a conductor plate with a third embodiment of a heat-conducting plate 11f, with a plurality of nestled, concentric, projecting walls 12f, which is supported by a conductor plate 4f Due to the plurality of walls, the surface area is enlarged and thus the capacity to transfer heat is improved.

FIG. 10 shows another option for enlarging the surface area. The fourth embodiment of a heat-conducting plate 11g shown here has a projecting wall 12g, which encloses an area having a plurality of projecting pins 13g. The heat-conducting plate 11g is also supported by a conductor plate 4g here.

Again with reference to FIG. 1, because an essential part of the heat generated by electronic components on the conductor plate 4 is discharged to the cooling medium by means of the heat-conducting path, which has the axle 2 and an axle retainer 8, 9 as components, which transfers the radial forces of the axle 2 from it to the separating wall 6 or the pump head 7, there is an especially large usable surface area by means of which the heat can be discharged to the conveyed medium.

In a development of the concept of the invention, a provision is that the first axle retainer 8 is fitted against the base of the separating wall 6, said base being arranged axially to an axis of rotation of the pump impeller 3. A further provision is that the second axle retainer 9 is arranged in an intake duct 10 of the pump head 7, and the conveyed medium at least partially flows around it during operation.

In order to use the thermal conductivity of the axle retainer to transfer heat, it is intended that the axle retainers 8, 9 consist of a metal material. Preferably, both axle retainers 8, 9 are made of a metal material with particularly good heat conductivity. Aluminum and magnesium are among the most suitable materials.

In what follows again with reference to FIG. 1, several options are listed as to how the heat can be efficiently transferred from the power components to the heat-conducting plate 4. These options can in each case be used singly or in combination with one or more of the other options. First, it is proposed that the conductor plate 4 have a plurality of vias (vertical interconnect access) forming a heat-conducting connection of power components through the conductor plate 4 to their opposite side and is in heat-conducting contact with the heat-conducting plate 11 directly there or via a heat-conducting medium.

A further option is that the conductor plate 4 have at least one recess through which a power component extends and is directly in heat-conducting contact with the heat-conducting plate 11 or via a heat-conducting medium (FIG. 7).

It is also conceivable that at least one conductor of the conductor plate 4 be directly in heat-conducting contact with the heat-conducting plate 11 or via a heat-conducting medium. The heat-conducting plate 11 preferably consists of aluminum or a material with comparable properties.

Finally, it is also possible for the heat-conducting plate 11 to form at least one electric conductor or a conductor area of the conductor plate 4.

A good transfer of heat from the conductor plate to the separating wall is achieved in that a heat-conducting plate 11 is arranged to tightly fit between the conductor plate 4 and the separating wall 6 and is a component of the heat-conducting path.

This transfer of heat can be optimized by enlarging the surface area of the heat-conducting plate and the separating wall; to this end the heat-conducting plate 11 has shapes that enlarge its surface area and which are matched to corresponding counter-shapes in the separating wall 6. It is proposed that the shapes consist of circumferential projecting walls 12 (FIGS. 8-10). As an alternative to this, the shapes may consist also of projecting pins 13 (FIG. 10).

In principle, all shapes enlarging the surface area are suitable that enable demolding from an injection mold and fulfill the design rules for such shapes. The same applies to manufacture of the heat-conducting plate.

The heat-conducting plate can be further improved in that the first axle retainer has a contact disk 14, whose extensive surface area tightly fits against the separating wall 6, and a retainer sleeve 15 for the axle 2. The retainer sleeve should have as extensive a surface area as possible and fill the existing installation space to the greatest extent possible.

The surface area of the first axle retainer 8 should also be selected to be as large as possible; to this end a support collar 16 connecting to the contact disk 14 is proposed, with the support collar providing radial support in a tube-shaped area 17 of the separating wall 6.

In order to transport as much heat as possible and in order to obtain the largest possible surface area in order to improve the transfer of heat, a provision is that the diameter of the axle 2 be at least 20% of the diameter of the first axle retainer 8 in the area of the contact disk 14. The axle discharges heat to its environment over its entire length in the conveyed medium; this can be optimized by the pump impeller 3 being mounted on the axle 2 by means of sleeve-like slide bearings 18, which divert a part of the heat absorbed by the axle to the pump impeller 3. To ensure this heat diversion is as great as possible, it is proposed that the length of a slide bearing 18 correspond to at least 10% of the length of the axle 2.

Because the axle 2 discharges heat continuously over its entire length, the axle diameter should be particularly large, particularly in the vicinity of the heat source, and can then be selected to be smaller in an area further away; in a development of the invention, the axle 2 should therefore have at least two differently sized diameter ranges, wherein the axle section with the larger diameter is retained in the first axle retainer 8. For reasons of cost, an axle with one single diameter, however, is preferred in many cases.

Because there is an especially high throughput of the conveyed medium in the intake duct, the heat can be discharged most effectively here; it is therefore very important to divert as much of the thermal energy as possible that occurs in the power components of the conductor plate up as far as the intake duct. This is optimized in that the second axle retainer 9 consists of material with good heat conductivity and has one additional slide bearing 31 (FIG. 2b) and at least one spoke 23, preferably three spokes, which form a single-piece body. The additional slide bearing 31 takes up the heat from the axle and diverts it to the spokes and also directly to the conveyed medium.

For reasons related to production and cost, the pump head is preferably produced from a plastic material, which can be processed through injection molding. In order to secure the aforementioned advantages, a provision is that the second axle retainer 9 be joined by molding to the pump head 7, particularly to an intake duct 10 of the pump head 7. To this end, the thermal expansion coefficients should be as close to one another as possible. This is the case when pairing PPS and aluminum.

As an alternative, the second axle retainer 9 is joined to the pump head 7, particularly to an intake duct 10 of the pump head 7, through pressing with force locking and/or positive locking. Preferably, a cone is provided here between the pump head 7 and the component consisting of the intake duct 10 and second axle retainer 9. In addition, the connection can be secured through bonding, welding, or bolting. If the sealing requirements demand it, an O-ring seal can also be placed between the parts to be joined. Alternatively, a liquid sealant can also be used.

In the optimum case, the intake duct 10 is a single-piece component of the second axle retainer 9. This enlarges the surface area of the heat-conducting parts again significantly. The intake duct 10 in this case is preferably joined by molding to the pump head 7, wherein the pump head consists of a plastic material that can be processed using injection molding.

The thermal conductivity of the separating wall can also be optimized by modifying the plastic material of which it consists. To this end, additives with good heat conductivity are added to the base material. A very effective way of improving the thermal conductivity of the cooling pad is for the axle to consist of aluminum, particularly an aluminum alloy.

Because aluminum does not have any optimal wear properties, a beneficial provision is that the axle be provided with a wear-resistant layer, particularly a molybdenum, chromium oxide, aluminum oxide, nickel, or bronze layer, at least in the bearing area.

As an alternative and with reference to FIGS. 2a and 2b, a provision is that at least one auxiliary slide bearing 31i, particularly a cylinder bearing, be pressed onto the axle, wherein the auxiliary slide bearing 31i consists of plastic, metal, a graphite-containing material, or a ceramic material. In order to ensure a defined position of the auxiliary slide bearing 31i on the axle, the axle is equipped with recesses 32i.

Ideally, at least one or preferably both axle retainers 8, 9 consists of an aluminum material. Essentially, it is important that the ratio between the diameter and length of the axle 2 be greater than 0.1, particularly greater than 0.15, and preferably greater than 0.2. The larger this ratio, the greater the thermal flow and thus the cooling effect which can be achieved.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

List of reference symbols

| | |
|---|---|
| 1 | Fluid pump |
| 2 | Axle |
| 3 | Pump impeller |
| 4 | Conductor plate |
| 5 | Dry area |
| 6 | Separating wall |
| 7 | Pump head |
| 8 | First axle retainer |
| 9 | Second axle retainer |
| 10 | Intake duct |
| 11 | Heat-conducting plate |
| 12 | Projecting wall |
| 13 | Projecting pin |
| 14 | Contact disk |
| 15 | Retainer sleeve |
| 16 | Support collar |
| 17 | Tube-shaped area |
| 18 | Slide bearing |
| 19 | Motor housing |
| 20 | Stator |
| 21 | Wet area |
| 22 | Disk-shaped area |
| 23 | Spoke |
| 24 | Groove |
| 25 | Output duct |
| 26 | Conductor lead-through |
| 27 | Flat plate |
| 28 | Connection pin |
| 29 | Capacitor |
| 30 | Coating |
| 31 | Auxiliary slide bearing |
| 32 | Recess |

What is claimed is:

1. A fluid pump for use in a cooling medium circuit, the fluid pump comprising:
an axle;
a wet area having a conveyed medium;
a dry area;
a pump impeller mounted on the axle so as to rotate around the axle in the conveyed medium in the wet area;
a conductor plate arranged in the dry area sealed off from the conveyed medium in the wet area, wherein radial forces of the axle are accommodated, on one side of the axle, by a separating wall between the dry area and the wet area and by a pump head on the other side of the axle; and
electronic components mounted on the conductor plate, the electronic components generating heat that is dissipated via a heat-conducting path to the cooling medium circuit, the heat conducting path including the axle and first and second axle retainers, which transfer the radial forces of the axle from the axle to the separating wall and the pump head.

2. The fluid pump according to claim 1, wherein the separating wall has a base and wherein the first axle retainer is fitted against the base, arranged axially to an axis of rotation of the pump impeller.

3. The fluid pump according to claim 1, wherein the pump head has a intake duct and wherein the second axle retainer is arranged in the intake duct of the pump head and the conveyed medium at least partially flows around it during operation.

4. The fluid pump according to claim 1, wherein a heat-conducting plate is arranged so as to tightly fit between the conductor plate and the separating wall and represents a component of the heat-conducting path.

5. The fluid pump according to claim 4, wherein the heat-conducting plate has shapes that enlarge its surface area, which are matched to corresponding counter-shapes in the separating wall.

6. The fluid pump according to claim 5, characterized in that the conductor plate has a plurality of vias, forming a heat-conducting connection of power components through the conductor plate to their opposite side and is in heat-conducting contact with the heat-conducting plate directly there or via a heat-conducting medium.

7. The fluid pump according to claim 5, wherein the conductor plate has at least one recess through which a power component extends and is directly in heat-conducting contact with the heat-conducting plate or via a heat-conducting medium.

8. The fluid pump according to claim 5, wherein the heat-conducting plate forms at least one electric conductor of the conductor plate.

9. The fluid pump according claim 5, wherein the axle has a retainer sleeve and wherein the first axle retainer has a contact disk, the extensive surface of which tightly fits against the separating wall, and the retainer sleeve.

10. The fluid pump according to claim 9, wherein the separating wall has a tube-shaped area and wherein the first axle retainer has a support collar connecting to the contact disk, with the support collar providing radial support in the tube-shaped area.

11. The fluid pump according to claim 1, wherein the pump impeller is mounted on the axle by means of sleeve-like slide bearings, which divert a part of the heat absorbed by the axle to the pump impeller.

12. The fluid pump according to claim 1, wherein the axle has at least two differently sized diameter ranges, wherein the axle section with the larger diameter is accommodated in the first axle retainer.

13. The fluid pump according to claim 1, wherein the second axle retainer consists of material with good heat conductivity and has one additional slide bearing and at least one spoke, which form a single-piece body.

14. The fluid pump according to claim 13, wherein the second axle retainer is joined by molding to the pump head, particularly an intake duct of the pump head, wherein the pump head consists of a plastic material, which can be processed through injection molding.

15. The fluid pump according to claim 13, wherein the intake duct is a single-piece component of the second axle retainer.

16. The fluid pump according to claim 15, wherein the intake duct is joined by molding to the pump head, wherein the pump head consists of a plastic material, which is processed through injection molding.

17. The fluid pump according to claim 1, wherein the axle is made of an aluminum alloy.

18. The fluid pump according to claim 17, wherein the axle is provided with a wear-resistant layer, particularly a molybdenum, chromium oxide, aluminum oxide, nickel, or bronze layer, at least in the bearing area.

19. The fluid pump according to claim 18, wherein at least one slide bearing is pressed onto the axle, wherein the slide bearing consists of plastic, metal, a graphite-containing material, or a ceramic material.

20. The fluid pump according to claim 1, wherein at least one axle retainer consists of an aluminum material.

21. The fluid pump according to claim 1, wherein the ratio between the diameter and length of the axle is greater than 0.1, particularly greater than 0.15, and preferably greater than 0.2.

22. The fluid pump according to claim 1, wherein at least one of the axle retainers consists of aluminum or magnesium.

23. The fluid pump according to claim 5, wherein the shapes consist of walls projecting all around.

24. The fluid pump according to claim 5, wherein the shapes consist of projecting pins.

25. The fluid pump according to claim 4, wherein the heat conducting plate forms at least one electric conductor or a conductor area of the conductor plate.

26. The fluid pump according to claim 9, wherein 16 the diameter of the axle is at least 20% of the diameter of the first axle retainer in the area of the contact wheel.

27. The fluid pump according to claim 11, wherein the length of a slide bearing corresponds to at least 10% of the length of the axle.

28. The fluid pump according to claim 13, wherein the second axle retainer is joined to the pump head through an intake duct of the pump head through a pressing force.

29. The fluid pump according to claim 1, wherein the material for the separating wall is modified with additives having good heat conductivity.
